(19) United States
(12) Patent Application Publication
(10) Pub. No.: US 2023/0274872 A1
(43) Pub. Date: Aug. 31, 2023

(54) COIL COMPONENT

(71) Applicant: Murata Manufacturing Co., Ltd., Kyoto-fu (JP)

(72) Inventors: Hiroyuki HONDA, Nagaokakyo-shi (JP); Masayuki ISHIDA, Nagaokakyo-shi (JP); Takuma SAGARA, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 18/170,015

(22) Filed: Feb. 16, 2023

(30) Foreign Application Priority Data
Feb. 28, 2022 (JP) 2022-029445

(51) Int. Cl. H01F 27/26; H01F 37/00; H01F 27/06; H01F 27/28; H01F 41/06

(52) U.S. Cl. CPC H01F 27/263; H01F 37/00; H01F 27/06; H01F 27/2828; H01F 41/06; H01F 2027/065

(57) ABSTRACT

A coil component capable of holding a core in a stable posture by a chuck in a winding step of a wire. The core includes a winding core portion extending in an axial direction, and a first flange portion and a second flange portion provided at end portions of the winding core portion opposite to each other in the axial direction. Each of outer end surfaces of the first flange portion and the second flange portion has a first ridge extending along a ridgeline where the outer end surfaces intersect first side surfaces and a second ridge extending along a ridgeline where the outer end surfaces intersect second side surfaces.

### CROSS-REFERENCE TO RELATED APPLICATION

This application claims benefit of priority to Japanese Patent Application No. 2022-029445, filed Feb. 28, 2022, the entire content of which is incorporated herein by reference.

### BACKGROUND

### Technical Field

The present disclosure relates to a winding-type coil component having a structure in which a wire is wound around a core, and particularly relates to a shape of a flange portion provided in the core.

### Background Art

For example, Japanese Patent Application Laid-Open No. 2009-16502 describes a method for manufacturing a common mode choke coil. In manufacturing the common mode choke coil, a step of winding a wire around a winding core portion provided in a core is performed. In the winding step, the wire is supplied from a nozzle toward the winding core portion while being traversed in a state where the core is rotated about a central axis of the winding core. As a result, the wire is spirally wound around the winding core portion.

In this winding step, in order to rotate the core as described above, the core is held by a chuck connected to a rotary drive source. The chuck is designed to grip one of two flange portions provided at end portions of the winding core portion opposite to each other in an axial direction.

More specifically, the flange portion usually has a mounting surface facing a mounting board side during mounting, a top surface facing an opposite side of the mounting surface, an inner end surface that faces the winding core portion side and positions the end portion of the winding core portion in the axial direction, an outer end surface that faces an opposite side of the inner end surface, the inner and outer end surfaces connecting the mounting surface and the top surface, and a first side surface and a second side surface that connect the inner end surface and the outer end surface and face in opposite directions to each other. On the other hand, the chuck usually has a surface coming into contact with the outer end surface of one flange portion and surfaces coming into contact with each of the first side surface and the second side surface of the flange portion.

An operation of the chuck gripping the flange portion is achieved by bringing a member that provides a surface coming into contact with the first side surface and a member that provides a surface coming into contact with the second side surface close to each other in a state where the chuck comes into contact with the outer end surface of the flange portion.

### SUMMARY

With the downsizing of the coil component, a dimension of the flange portion, more specifically, a dimension between the outer end surface and the inner end surface of the flange portion becomes shorter. As a result, areas where the first side surface and the second side surface of the flange portion come into contact with the chuck are reduced, it is difficult to hold the core in a stable posture by the chuck. Thus, a rotation central axis of the core deviates from the central axis of the winding core portion, and the core may not be appropriately rotated.

In order to increase the possible number of windings of the wire in the winding core portion without increasing the size of the coil component, it is considered that a thickness of the flange portion is further decreased while a dimension of the winding core portion in the axial direction is further increased, but in this case, the above-described problem becomes more remarkable.

Therefore, the present disclosure provides a coil component capable of holding a core in a stable posture by a chuck in a winding step of a wire.

The present disclosure provides a coil component including a core that has a winding core portion extending in an axial direction and a first flange portion and a second flange portion provided at end portions of the winding core portion opposite to each other in the axial direction, a first terminal electrode that is provided at the first flange portion, a second terminal electrode that is provided at the second flange portion, and at least one wire that is connected to the first terminal electrode and the second terminal electrode, and is wound around the winding core portion.

Each of the first flange portion and the second flange portion has a mounting surface facing a mounting board side during mounting, a top surface facing an opposite side of the mounting surface, an inner end surface that faces the winding core portion side and positions the end portion of the winding core portion in the axial direction, an outer end surface that faces an opposite side of the inner end surface, the inner and outer end surfaces connecting the mounting surface and the top surface, and a first side surface and a second side surface that connect the inner end surface and the outer end surface, and face in opposite directions to each other.

In the present disclosure, each of the outer end surfaces of the first flange portion and the second flange portion has the first ridge extending along the ridgeline where the outer end surface intersects the first side surface and the second ridge extending along the ridgeline where the outer end surface intersects the second side surface.

According to the present disclosure, though the coil component is downsized and the core is downsized, since the contact area between the chuck and the flange portion or the region where the contact portion is distributed can be secured to be relatively large due to the presence of the first ridge and the second ridge, the core can be held in a stable posture in the winding step of the wire.

### BRIEF DESCRIPTION OF THE DRAWINGS

FIG. 1 is a perspective view illustrating an appearance of a coil component according to a first embodiment of the present disclosure with mounting surfaces facing upward;

FIG. 2 is a bottom view illustrating the appearance of the coil component illustrated in FIG. 1 from the mounting surfaces;

FIG. 3 is a front view illustrating the appearance of the coil component illustrated in FIG. 1 with the mounting surfaces facing upward;

FIG. 4 is a left side view illustrating the appearance of the coil component illustrated in FIG. 1 with the mounting surfaces facing upward;

FIG. 5 is a perspective view illustrating an appearance of a core provided in the coil component illustrated in FIG. 1 with the mounting surfaces facing upward;

FIG. 6 is a bottom view illustrating the appearance of the core illustrated in FIG. 5 from the mounting surfaces;

FIG. 7 is a front view illustrating the appearance of the core illustrated in FIG. 5 with the mounting surfaces facing upward;

FIG. 8 is a left side view illustrating the appearance of the core illustrated in FIG. 5 with the mounting surfaces facing upward;

FIG. 9 is an enlarged view illustrating a part of the right side view illustrated in FIG. 4;

FIG. 10 is a sectional view taken along line X-X in FIG. 9;

FIG. 11 is a perspective view illustrating an appearance of a coil component according to a second embodiment of the present disclosure of the disclosure with mounting surfaces facing upward; and

FIG. 12 is a perspective view illustrating an appearance of a core provided in the coil component illustrated in FIG. 11 with the mounting surfaces facing upward.

### DETAILED DESCRIPTION

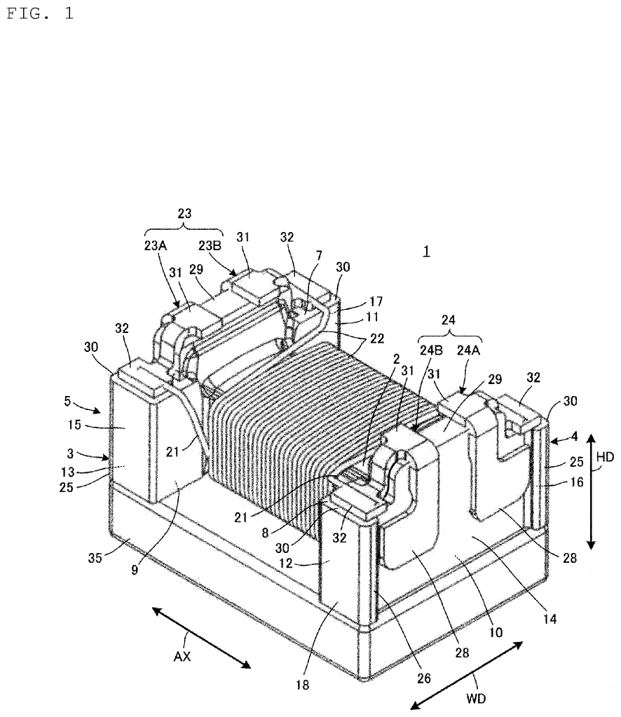

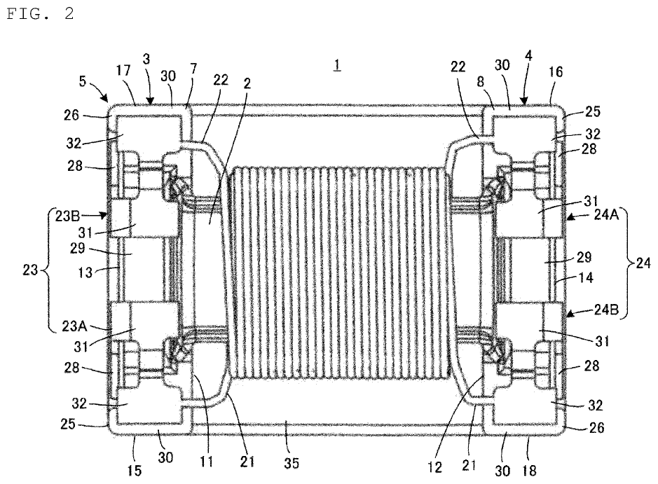

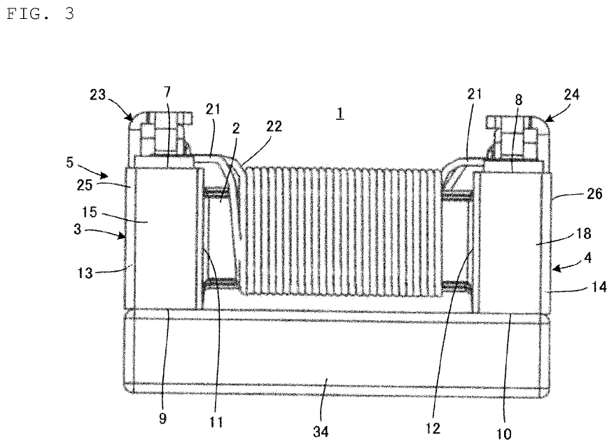

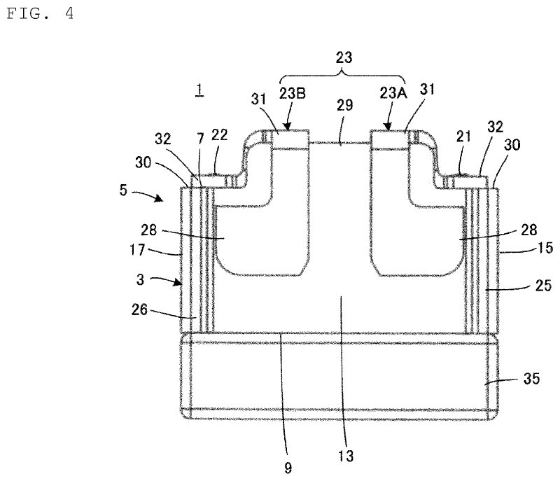

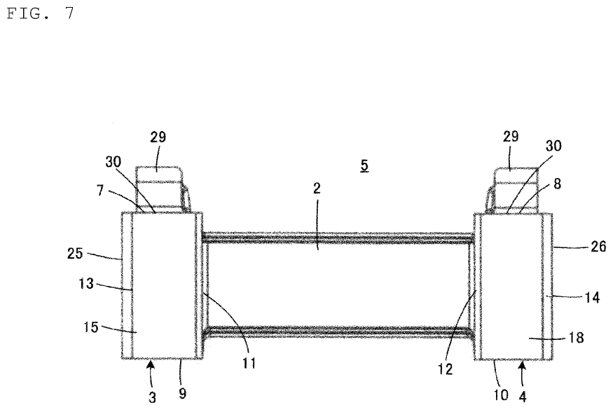

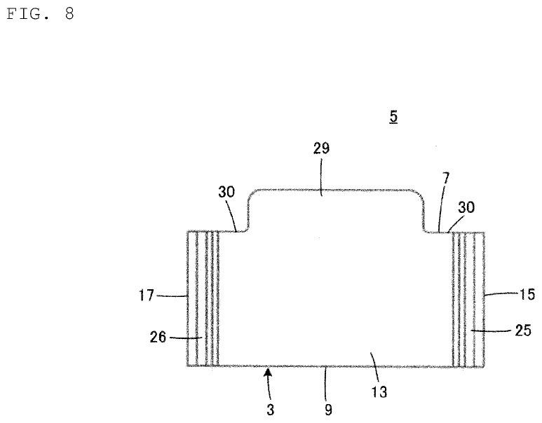

A coil component 1 according to a first embodiment of the present disclosure will be described with reference to FIGS. 1 to 10.

The coil component 1 includes a drum-shaped core 5 having a winding core portion 2 extending in an axial direction AX and a first flange portion 3 and a second flange portion 4 provided at end portions of the winding core portion 2 opposite to each other in the axial direction AX. The core 5 is made of, for example, ferrite, or resin containing ferrite powder or metal magnetic powder. The winding core portion 2 has a substantially quadrangular sectional shape in the drawing, but may have a polygonal shape such as a hexagonal shape, a circular shape, an elliptical shape, or a shape obtained by combining these shapes.

The first flange portion 3 includes a mounting surface 7 facing a mounting board side during mounting, a top surface 9 facing an opposite side of the mounting surface 7, an inner end surface 11 that faces the winding core portion 2 side and positions the end portion of the winding core portion 2 in the axial direction AX, an outer end surface 13 that faces an opposite side of the inner end surface 11, the inner and outer end surfaces connecting the mounting surface 7 and the top surface 9, a first side surface 15 and a second side surface 17 that connect the inner end surface 11 and the outer end surface 13 and face in opposite directions to each other.

Similarly, the second flange portion 4 has a mounting surface 8 facing a mounting board side during mounting, a top surface 10 facing an opposite side of the mounting surface 8, an inner end surface 12 that faces the winding core portion 2 side and positions the end portion of the winding core portion 2 in the axial direction AX, an outer end surface 14 that faces an opposite side of the inner end surface 12, the inner and outer end surfaces connecting the mounting surface 8 and the top surface 10, and a first side surface 16 and a second side surface 18 that connect the inner end surface 12 and the outer end surface 14 and face in opposite directions to each other.

As an example, the core 5 has a dimension of 3.5 mm in the axial direction AX, a dimension of 2.6 mm in a width direction WD in which the first side surfaces 15 and 16 and the second side surfaces 17 and 18 face each other, and a dimension of 1.4 mm in a height direction HD in which the mounting surfaces 7 and 8 and the top surfaces 9 and 10 face each other.

The coil component 1 constitutes, for example, a common mode choke coil, and includes a first wire 21 and a second wire 22 wound around the winding core portion 2 of the core 5. In the common mode choke coil, as is well known, the first wire 21 and the second wire 22 are wound in the same direction around the winding core portion 2. In the illustrated example, the first wire 21 is wound around the winding core portion 2 to come into contact with the winding core portion 2, and the second wire 22 is wound to come into contact with an outer periphery of the first wire 21. Each of the wires 21 and 22 includes, for example, a center wire material made of a favorable conductive metal such as copper, silver, or gold, and an insulating film covering the center wire material and made of an electrically insulating resin such as polyamideimide, polyurethane, or polyesterimide. It is preferable that wires having a diameter of 20 μm or more and 60 μm or less (i.e., from 20 μm to 60 μm) are used as the wires 22 and 21.

First terminal electrodes 23 are provided at the first flange portion 3, and second terminal electrodes 24 are provided at the second flange portion 4. Two first terminal electrodes 23 spaced apart from each other and aligned in the width direction WD are provided at the first flange portion 3, and two second terminal electrodes 24 spaced apart from each other and aligned in the width direction WD are provided at the second flange portion 4.

In order to distinguish two first terminal electrodes 23 from each other, one first terminal electrode is denoted by reference symbol “23A”, the other first terminal electrode is denoted by reference symbol “23B”, and in a case where two second terminal electrodes 24 are to be distinguished from each other, one second terminal electrode is denoted by reference symbol “24A”, and the other second terminal electrode is denoted by reference symbol “24B”.

A first end portion and a second end portion of the first wire 21 are connected to the first terminal electrode 23A and the second terminal electrode 24B by thermal pressure bonding. A first end portion and the second end portion of the second wire 22 are connected to the first terminal electrode 23B and the second terminal electrode 24A by thermal pressure bonding.

A first ridge 25 extending along a ridgeline where the outer end surface 13 intersects the first side surface 15 and a second ridge 26 extending along a ridgeline where the outer end surface 13 intersects the second side surface 17 are provided on the outer end surface 13 of the first flange portion 3.

Similarly, a first ridge 25 extending along a ridgeline where the outer end surface 14 intersects the first side surface 16 and a second ridge 26 extending along a ridgeline where the outer end surface 14 intersects the second side surface 18 are provided on the outer end surface 14 of the second flange portion 4.

As an example, the first ridge 25 and the second ridge 26 have a dimension of 0.2 mm in the width direction and a protrusion height of 0.1 mm.

According to this configuration, though the coil component 1 is downsized and the core 5 is downsized, since contact areas between a chuck and the flange portions 3 and 4 or regions where contact portions are distributed can be secured to be relatively large due to the presence of the first ridge 25 and the second ridge 26, the core 5 can be held in a stable posture in a winding step of the wires 21 and 22.

It is preferable that the first terminal electrode 23 and the second terminal electrode 24 described above are formed by using a metal plate having a thickness equal to or less than the protrusion height of the first ridge 25 and the second ridge 26. For example, a metal plate in which an element body is made of copper and a surface facing an outside is plated with nickel and tin in this order is used as the metal plate constituting the terminal electrodes 23 and 24.

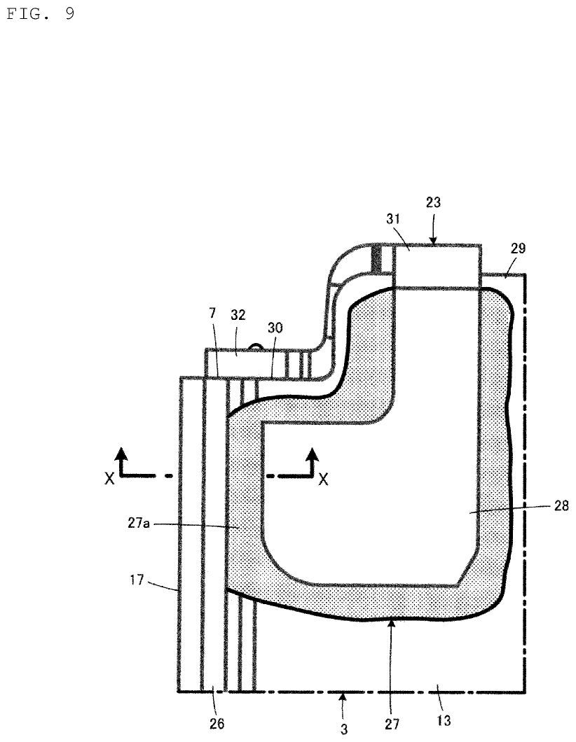

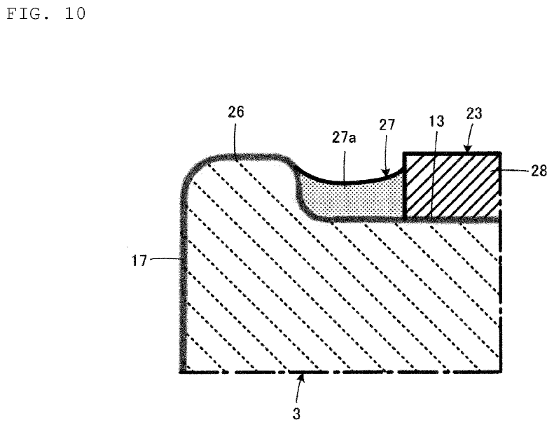

The first terminal electrode 23 has a fixing portion 28 disposed along a region of the outer end surface 13 of the first flange portion 3 where the first ridge 25 and the second ridge 26 are not provided and fixed to the first flange portion 3 with an adhesive 27 interposed therebetween (see FIGS. 9 and 10). Similarly, the second terminal electrode 24 has a fixing portion 28 disposed along a region of the outer end surface 14 of the second flange portion 4 where the first ridge 25 and the second ridge 26 are not provided and fixed to the second flange portion 4 with the adhesive 27 interposed therebetween.

With the above configuration, the first terminal electrode 23, the second terminal electrode 24, and the adhesive 27 do not interfere with the chuck. Thus, the core 5 can be held in a stable posture by the chuck in the winding step of the wires 21 and 22.

As illustrated in FIGS. 9 and 10, it is preferable that the adhesive 27 described above forms an adhesive layer 27a and the adhesive layer 27a is positioned to fill a space between each of the first ridge 25 and the second ridge 26 and the fixing portion 28. The presence of the adhesive layer 27a contributes to improvement in bonding strength of the first terminal electrode 23 and the second terminal electrode 24 to the first flange portion 3 and the second flange portion 4.

For example, a thermosetting epoxy resin is used as the adhesive 27. An inorganic filler such as a silica filler may be added to the adhesive 27 in order to improve thermal shock resistance of the adhesive 27. A dispensing method can be adopted as a method for applying the adhesive 27.

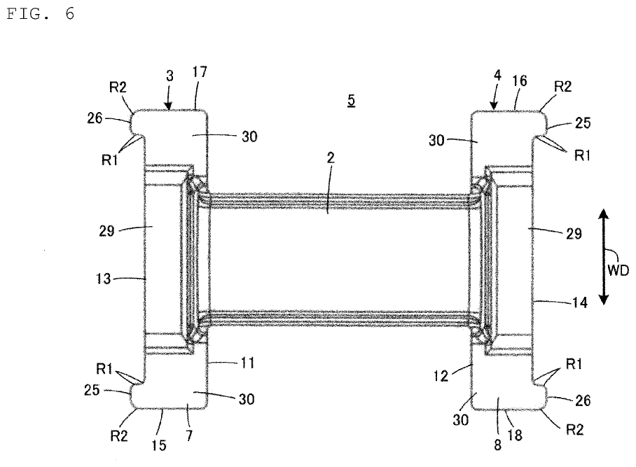

As well illustrated in FIG. 6, two first rounded surfaces R1 are formed at an end edge on the second side surfaces 17 and 18 side of the first ridge 25 and an end edge on the first side surfaces 15 and 16 side of the second ridge 26, and second rounded surfaces R2 are formed at an end edge on the first side surfaces 15 and 16 side of the first ridge 25 and an end edge on the second side surfaces 17 and 18 side of the second ridge 26. It is preferable that a radius of curvature defining the first rounded surface R1 is smaller than a radius of curvature defining the second rounded surface R2. As a result, the adhesive 27 is less likely to wet and spread to an outer periphery of the core 5, and the adhesive 27 can prevent or suppress an undesired increase in an outer dimension of the coil component 1.

As well illustrated in FIG. 6, it is preferable that dimensions of the regions of the outer end surfaces 13 and 14 where the first ridge 25 and the second ridge 26 are not provided in the width direction WD are larger than a dimension of the winding core portion 2 in the width direction WD. The larger the dimensions of the regions of the outer end surfaces 13 and 14 where the first ridge 25 and the second ridge 26 are not provided in the width direction WD, the larger the contact areas between the fixing portions 28 of the terminal electrodes 23 and 24 and the outer end surfaces 13 and 14 can be, and thus, the higher the fixing strength of the terminal electrodes 23 and 24 to the flange portions 3 and 4 can be.

As well illustrated in FIGS. 1, 4, 5, 8, and the like, it is preferable that raised portions 29 raised at central portions in the width direction WD are provided on the mounting surfaces 7 and 8 of the first flange portion 3 and the second flange portion 4, and shoulder portions 30 lower than the raised portion 29 are formed on both sides of the raised portion 29 in the width direction.

The first terminal electrode 23 and the second terminal electrode 24 have portions curved and extending in an S-shape along the raised portions 29 and the shoulder portions 30 on the mounting surfaces 7 and 8 of the first flange portion 3 and the second flange portion 4.

In the first terminal electrode 23 and the second terminal electrode 24, connection portions with a mounting board (not illustrated.) are provided by portions 31 extending along the raised portions 29, and connection portions with the wires 21 and 22 are provided by portions 32 extending along the shoulder portions 30.

According to such a configuration, since a sufficient distance can be secured between the connection portions with the wires 21 and 22 in the terminal electrodes 23 and 24 and the connection portions with the mounting board, a flux for soldering for connection to the mounting board can be difficult to penetrate into the coil component 1 along the wires 21 and 22.

The first ridge 25 and the second ridge 26 described above are in contact with the portions 32 extending along the shoulder portions 30 in the first terminal electrode 23 and the second terminal electrode 24. As a result, since the portions 32 of the terminal electrodes 23 and 24 extending along the shoulder portions 30 which are the connection portions with the wires 21 and 22 can be supported by the contact between the first ridge 25 and the second ridge 26, the positions of the portions 32 of the terminal electrodes 23 and 24 can be stably and firmly maintained in a thermal pressure bonding step of the wires 21 and 22.

The terminal electrodes 23 and 24 may be constituted by conductor films formed on the flange portions 3 and 4 instead of the metal plate. In this case, for example, base electrodes are formed on the mounting surfaces 7 and 8 of the flange portions 3 and 4 by baking a silver paste, base electrodes are formed on the outer end surfaces 13 and 14 of the flange portions 3 and 4 by vapor deposition of silver, and copper, nickel, and tin are plated on the base electrodes in this order.

In the dimensions measured in the axial direction AX, it is preferable that the dimension of the winding core portion 2 is three times or more and four times or less (i.e., from three times to four times) the dimension (dimension from each of the inner end surfaces 11 and 12 to each of the outer end surfaces 13 and 14 including the ridges 25 and 26) of each of the first flange portion 3 and the second flange portion 4. According to this configuration, the possible number of windings of the wires 21 and 22 in the winding core portion 2 can be increased without increasing the size of the coil component 1.

In the first flange portion 3, the sum of the dimension of the first ridge 25 in the width direction and the dimension of the second ridge 26 in the width direction is preferably ½ or less, more preferably ⅓ or less of the distance between the first side surface 15 and the second side surface 17. Similarly, in the second flange portion 4, the sum of the dimension of the first ridge 25 in the width direction and the dimension of the second ridge 26 in the width direction is preferably ½ or less, more preferably ⅓ or less of the distance between the first side surface 16 and the second side surface 18.

According to the above configuration, an effect is exhibited when the core 5 is compression-molded. That is, when the core 5 is compression-molded, in a case where the mounting surfaces 7 and 8 and the top surfaces 9 and 10 are set to be upper and lower surfaces, and powder as a molding material is pressed from an upper-lower direction, a pressure can be sufficiently applied to the portions of the ridges 25 and 26. Accordingly, sufficient strength can be secured in the ridges 25 and 26.

A top plate 35 is provided at the coil component 1 to connect the top surface 9 of the first flange portion 3 of the core 5 and the top surface 10 of the second flange portion 4. The top plate 35 is bonded to the core 5 with an adhesive. For example, a thermosetting epoxy resin is used as the adhesive. An inorganic filler such as a silica filler may be added to the adhesive in order to improve thermal shock resistance of the adhesive. A printing method for applying the adhesive to the top plate 35, a method for dipping the top surfaces 9 and 10 of the flange portions 3 and 4 of the core 5 into the adhesive, a method for dispensing and applying the adhesive to both the top plate 35 and the core 5, and the like can be adopted as the method for applying the adhesive. Ferrite, a non-conductive material other than ferrite, ferrite powder, a resin containing metal magnetic powder, or the like is used as a material of the top plate 35. In a case where both the core 5 and the top plate 35 are made of a magnetic material, the core 5 and the top plate 35 constitute a closed magnetic circuit. Coating with resin may be applied instead of the top plate 35. The top plate 35 may not be provided, or the resin coating may not be provided.

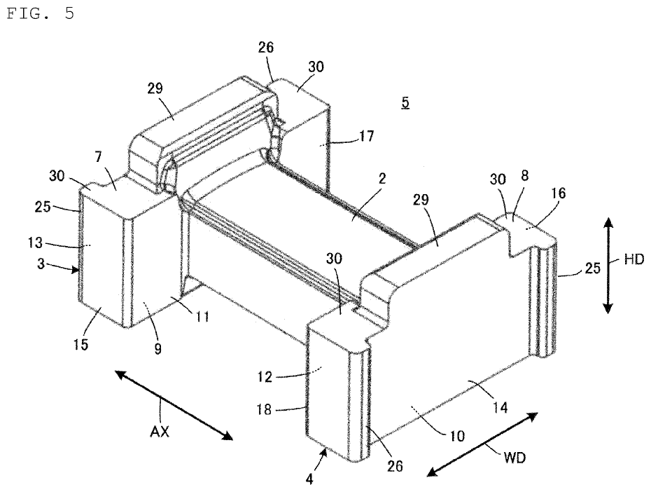

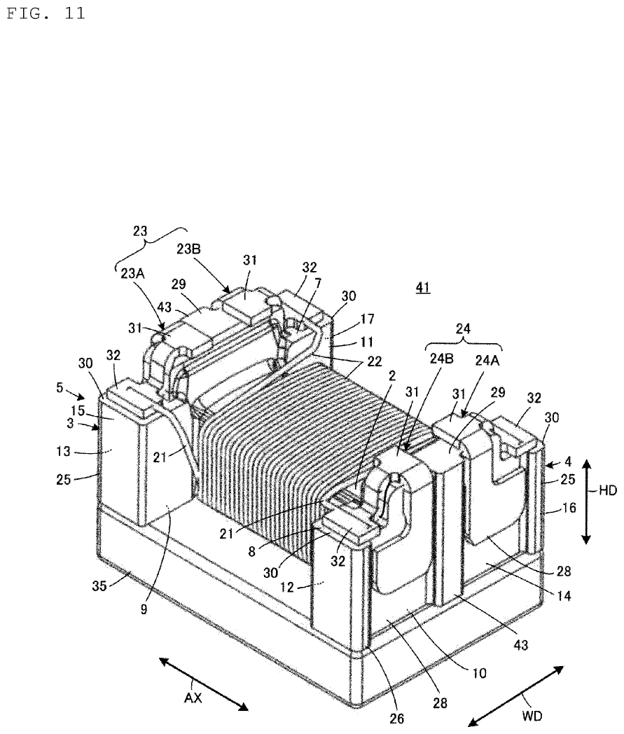

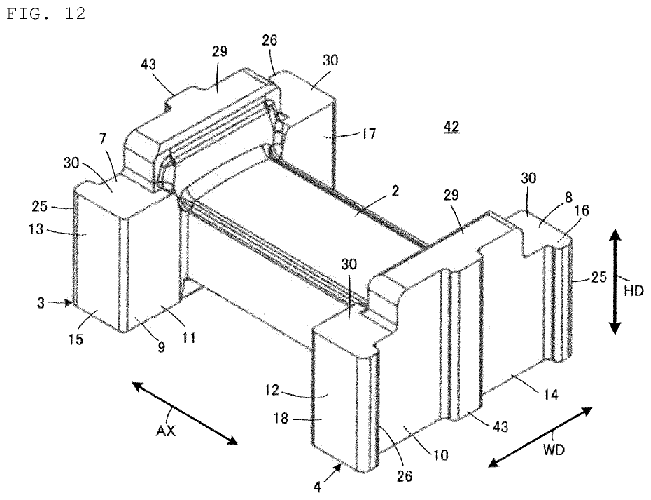

FIG. 11 is a perspective view illustrating an appearance of a coil component 41 according to a second embodiment of the present disclosure with the mounting surfaces 7 and 8 facing upward. FIG. 12 is a perspective view illustrating an appearance of a core 42 provided in the coil component 41 illustrated in FIG. 11 with the mounting surfaces 7 and 8 facing upward. FIG. 11 corresponds to FIG. 1, and FIG. 12 corresponds to FIG. 5. In FIGS. 11 and 12, elements corresponding to the elements illustrated in FIGS. 1 and 5 are denoted by the same reference symbols, and redundant description is omitted.

As compared with the coil component 1 according to the first embodiment, the coil component 41 according to the second embodiment is characterized in that third ridges 43 are further provided between the first ridge 25 and the second ridge 26 on the outer end surfaces 13 and 14 of the first flange portion 3 and the second flange portion 4. As an example, the third ridge 43 has a dimension of 0.4 mm in the width direction and a protrusion height of 0.1 mm.

Since the presence of the third ridge 43 can secure larger contact areas between the chuck and the flange portions 3 and 4, the core 5 can be held in a more stable posture in the winding step of the wires 21 and 22.

Although one third ridge 43 is provided at a center in the width direction of each of the outer end surfaces 13 and 14, a plurality of third ridges may be provided by appropriately changing the arrangement.

Although the present disclosure has been described in conjunction with the illustrated embodiments, various other embodiments are possible within the scope of the present disclosure.

For example, the coil component to which the present disclosure is directed may constitute a single coil or may constitute a transformer, a balun, or the like other than a common mode choke coil as in the illustrated embodiments. Accordingly, the number of wires is also changed according to a function of the coil component, and the number of terminal electrodes provided on each flange portion can also be changed accordingly.

In configuring the coil component according to the present disclosure, partial replacement or combination of configurations is possible between different embodiments described in this specification.

What is claimed is:

1. A coil component comprising:
a core that has a winding core portion extending in an axial direction and a first flange portion and a second flange portion at end portions of the winding core portion opposite to each other in the axial direction;
a first terminal electrode at the first flange portion;
a second terminal electrode at the second flange portion; and
at least one wire that is connected to the first terminal electrode and the second terminal electrode, and is wound around the winding core portion,
wherein each of the first flange portion and the second flange portion includes:
a mounting surface facing a mounting board side during mounting,
a top surface facing opposite to the mounting surface,
an inner end surface that faces the winding core portion side and is at a respective one of the end portions of the winding core portion in the axial direction,
an outer end surface that faces opposite to the inner end surface, the inner and outer end surfaces connecting the mounting surface and the top surface, and
a first side surface and a second side surface that connect the inner end surface and the outer end surface, and face opposite to each other, and
the outer end surface of each of the first flange portion and the second flange portion has a first ridge extending along a ridgeline where the outer end surface intersects the first side surface and a second ridge extending along a ridgeline where the outer end surface intersects the second side surface.

2. The coil component according to claim 1, wherein
the first terminal electrode and the second terminal electrode are configured of a metal plate having a thickness equal to or less than protrusion heights of the first ridge and the second ridge, and have fixing portions disposed along regions of the outer end surfaces where the first ridge and the second ridge are absent, the fixing portions being fixed to the first flange portion and the second flange portion with an adhesive interposed therebetween.

3. The coil component according to claim 2, wherein
an adhesive layer of the adhesive fills a space between each of the first ridge and the second ridge and the fixing portion.

4. The coil component according to claim 3, wherein
first rounded surfaces are at an end edge of the second side surface side of the first ridge and at an end edge of the first side surface side of the second ridge, and second rounded surfaces are at an end edge of the first side surface side of the first ridge and at an end edge of the second side surface side of the second ridge, and
a radius of curvature defining the first rounded surface is smaller than a radius of curvature defining the second rounded surface.

5. The coil component according to claim 2, wherein
when a direction in which the first side surface and the second side surface face is defined as a width direction, a dimension in the width direction of the region of the outer end surface where the first ridge and the second ridge are absent is larger than a dimension in the width direction of the winding core portion.

6. The coil component according to claim 1, wherein
the first terminal electrode and the second terminal electrode are configured of a metal plate,
when a direction in which the first side surface and the second side surface face is defined as a width direction, a raised portion raised at a central portion in the width direction is on the mounting surface of each of the first flange portion and the second flange portion, and shoulder portions lower than the raised portion are on both sides of the raised portion in the width direction,
the first terminal electrode and the second terminal electrode have portions of the mounting surfaces of the first flange portion and the second flange portion extending along the raised portions and portions of the mounting surfaces of the first flange portion and the second flange portion extending along the shoulder portions,
each of the first terminal electrode and the second terminal electrode includes a first connection portion with the mounting board which is configured by the portion extending along the raised portion, and a second connection portion with the wire which is configured by the portion extending along the shoulder portions, and
at least one of the first ridge and the second ridge is in contact with the portion of each of the first terminal electrode and the second terminal electrode extending along the shoulder portions.

7. The coil component according to claim 1, wherein
in the axial direction, a dimension of the winding core portion is from three times to four times of a dimension of each of the first flange portion and the second flange portion.

8. The coil component according to claim 1, wherein
when a direction in which the first side surface and the second side surface face is defined as a width direction, a total of a dimension of the first ridge in the width direction and a dimension of the second ridge in the width direction is ½ or less of a distance between the first side surface and the second side surface.

9. The coil component according to claim 8, wherein
the total of the dimension of the first ridge in the width direction and the dimension of the second ridge in the width direction is ⅓ or less of the distance between the first side surface and the second side surface.

10. The coil component according to claim 1, wherein
at least one third ridge is on the outer end surface between the first ridge and the second ridge.

11. The coil component according to claim 10, wherein
when a direction in which the first side surface and the second side surface face is defined as a width direction, a dimension of the region of the outer end surface in the width direction where none of the first ridge, the second ridge, and the third ridge are present is larger than a dimension of the winding core portion in the width direction.

12. The coil component according to claim 10, wherein
when a direction in which the first side surface and the second side surface face is defined as a width direction, a total of a dimension of the first ridge in the width direction, a dimension of the second ridge in the width direction, and a dimension of the third ridge in the width direction is ½ or less of a distance between the first side surface and the second side surface.

13. The coil component according to claim 12, wherein
the total of the dimension of the first ridge in the width direction, the dimension of the second ridge in the width direction, and the dimension of the third ridge in the width direction is ⅓ or less of the distance between the first side surface and the second side surface.

14. The coil component according to claim 3, wherein
when a direction in which the first side surface and the second side surface face is defined as a width direction, and a dimension of the region of the outer end surface in the width direction where the first ridge and the second ridge are absent is larger than a dimension of the winding core portion in the width direction.

15. The coil component according to claim 4, wherein
when a direction in which the first side surface and the second side surface face is defined as a width direction, and a dimension of the region of the outer end surface in the width direction where the first ridge and the second ridge are absent is larger than a dimension of the winding core portion in the width direction.

16. The coil component according to claim 2, wherein
the first terminal electrode and the second terminal electrode are configured of a metal plate,
when a direction in which the first side surface and the second side surface face is defined as a width direction, a raised portion raised at a central portion in the width direction is on the mounting surface of each of the first flange portion and the second flange portion, and shoulder portions lower than the raised portion are on both sides of the raised portion in the width direction,
the first terminal electrode and the second terminal electrode have portions of the mounting surfaces of the first flange portion and the second flange portion extending along the raised portions and portions of the mounting surfaces of the first flange portion and the second flange portion extending along the shoulder portions,
each of the first terminal electrode and the second terminal electrode includes a first connection portion with the mounting board which is configured by the portion extending along the raised portion, and a second connection portion with the wire which is configured by the portion extending along the shoulder portions, and
at least one of the first ridge and the second ridge is in contact with the portion of each of the first terminal electrode and the second terminal electrode extending along the shoulder portions.

17. The coil component according to claim 2, wherein
in the axial direction, a dimension of the winding core portion is from three times to four times of a dimension of each of the first flange portion and the second flange portion.

18. The coil component according to claim 2, wherein
when a direction in which the first side surface and the second side surface face is defined as a width direction, a total of a dimension of the first ridge in the width direction and a dimension of the second ridge in the width direction is ½ or less of a distance between the first side surface and the second side surface.

19. The coil component according to claim 2, wherein
at least one third ridge is on the outer end surface between the first ridge and the second ridge.

20. The coil component according to claim 11, wherein
when a direction in which the first side surface and the second side surface face is defined as a width direction, a total of a dimension of the first ridge in the width direction, a dimension of the second ridge in the width direction, and a dimension of the third ridge in the width direction is ½ or less of a distance between the first side surface and the second side surface.
